(19) United States
(12) Patent Application Publication
(10) Pub. No.: US 2008/0262720 A1
(43) Pub. Date: Oct. 23, 2008

(54) DRIVING RECORDER

(75) Inventor: Chen-Chiang CHU, Jhonghe City (TW)

Correspondence Address: PATENTTM.US, P. O. BOX 82788, PORTLAND, OR, 97282-0788, US

(73) Assignee: KRETON CORPORATION, Jhonghe City (TW)

(21) Appl. No.: 12/105,193

(22) Filed: Apr. 17, 2008

(30) Foreign Application Priority Data
Apr. 23, 2007 (TW) 096114213

(51) Int. Cl. G01C 21/00

(52) U.S. Cl. 701/207

(57) ABSTRACT

A driving recorder is installed on a vehicle and has a processor, a register, a gravity sensing unit, a magnetic field positioning unit, a camera and a storage unit. The gravity sensing unit is electronically connected to the processor and uses gravity as a reference for detecting a movement of the vehicle to allow the processor to calculate a motion and orientation of the vehicle and determine whether the vehicle is colliding. The magnetic field positioning unit is electronically connected to the processor and detects a position of the magnetic field positioning unit by measuring the Earth's magnetic field so the processor calculate a location of the vehicle. Therefore, the driving recorder accurately detects motion, orientation and location of the vehicle even when the vehicle is being driven in a tunnel.

### BACKGROUND OF THE INVENTION

1. Field of the Invention

The present invention relates to a driving recorder, and more particularly to a driving recorder being installed easily on a vehicle for calculating an orientation and location of the vehicle without receiving externally generated signals.

2. Description of Related Art

Vehicles are in common use today, but as vehicles become more expensive and insurance claims assigning blame more costly, a reliable guard against burglary and way of tracking driving speeds and movement are required. A conventional driving recorder is electronically connected using wires to a speed sensor, steering wheel, throttle and brake in the vehicle to detect and log speed of the vehicle, direction of the steering wheel direction, throttle status and brake status. Furthermore, the conventional driving recorder is connected to a camera to capture images around the vehicle especially when the vehicle is in a collision. However, connecting the conventional driving recorder with the speed sensor, steering wheel, throttle and brake complicate wiring in the vehicle causing high installation costs. Furthermore, the driving recorder cannot detect driving conditions, such as spatial orientation of the vehicle and if the vehicle is ascending or descending.

Since a location cannot be given and recorded, the conventional driving recorder may further be connected to a global positioning system (GPS) device. The GPS device receives signals transmitted by satellites to determine position and speed of the vehicle. However, the GPS device does not work if the signals transmitted by the satellites are shielded or obstructed, such as when the vehicle is driven in a tunnel. Since the GPS device can only gauge the location to a certain accuracy, the application of the location is also limited, especially when a few centimeters and not meters are important, such as assigning blame in accident scenes.

To overcome the shortcomings, the present invention provides a driving recorder being installed easily on a vehicle and positioning the location of the vehicle without receiving radio waves to mitigate or obviate the aforementioned problems.

### SUMMARY OF THE INVENTION

The main objective of the present invention is to provide a driving recorder being installed easily on a vehicle for calculating an orientation and location of the vehicle without externally generated signals.

The driving recorder in accordance with the present invention is installed on a vehicle and comprises a processor, a register, a gravity sensing unit, a magnetic field positioning unit, a camera and a storage unit. The gravity sensing unit is electronically connected to the processor and uses gravity as a reference for detecting a movement of the vehicle to allow the processor to calculate a motion and orientation of the vehicle and determine whether the vehicle is colliding. The magnetic field positioning unit is electronically connected to the processor and detects a position of the magnetic field positioning unit by measuring the Earth's magnetic field so the processor calculate a location of the vehicle. Therefore, the driving recorder accurately detects motion, orientation and location of the vehicle even when the vehicle is being driven in a tunnel.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of an embodiment of a driving recorder in accordance with the present invention;

FIGS. 2A to 2D show a circuit diagram of a processor in FIG. 1;

FIGS. 3A to 3G show a circuit diagram of a register and a storage unit in FIG. 1;

FIGS. 4A to 4P show a circuit diagram of a gravity sensing unit, an image transmitting interface, a video encoder and a card type storage medium connector in FIG. 1;

FIGS. 5A to 5L show a circuit diagram of a universal asynchronous receiver and transmitter interface and a removable storage medium connector in FIG. 1;

FIGS. 6A to 6I show a circuit diagram of a network adapter connector in FIG. 1;

FIGS. 7A to 7U show a circuit diagram of a clock unit in FIG. 1; and

FIG. 8 is a flow chart of a collision determining process in accordance with the present invention.

### DETAILED DESCRIPTION OF PREFERRED EMBODIMENT

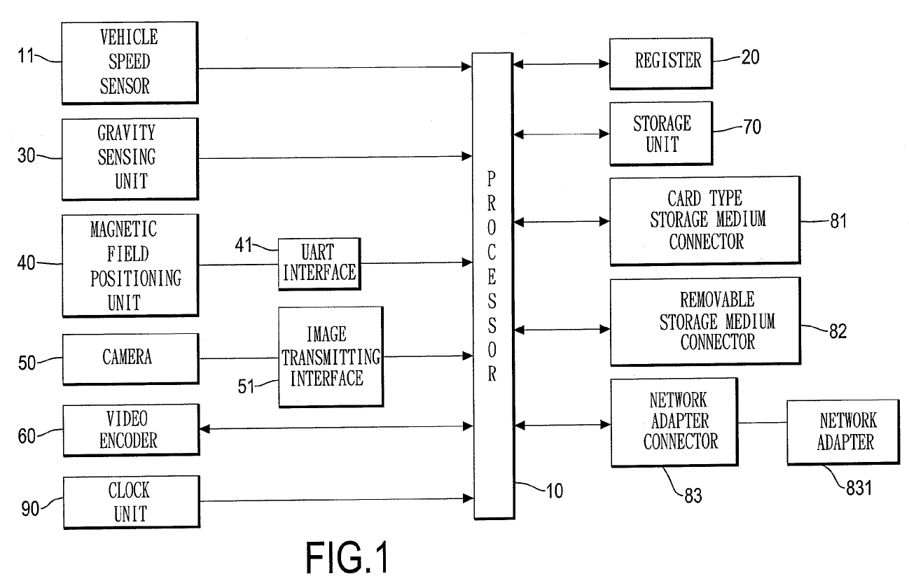

A driving recorder in accordance with the present invention is disposed on a vehicle. With reference to FIG. 1, the driving recorder in accordance with the present invention comprises a processor (10), an optional vehicle speed sensor (11), a register (20), a gravity sensing unit (30), a magnetic field positioning unit (40), a camera (50), an optional video encoder (60), a storage unit (70), an optional card type storage medium connector (81), an optional removable storage medium connector (82), an optional network adapter connector (83) and a clock unit (90).

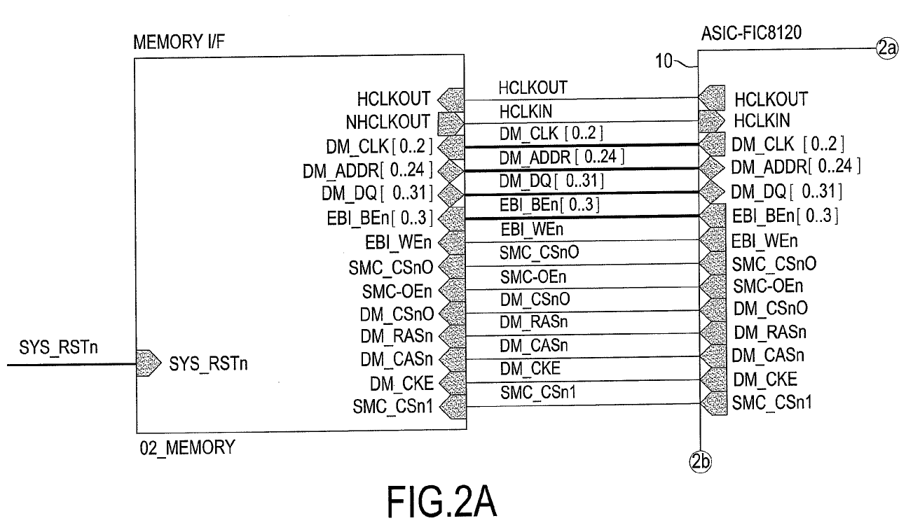

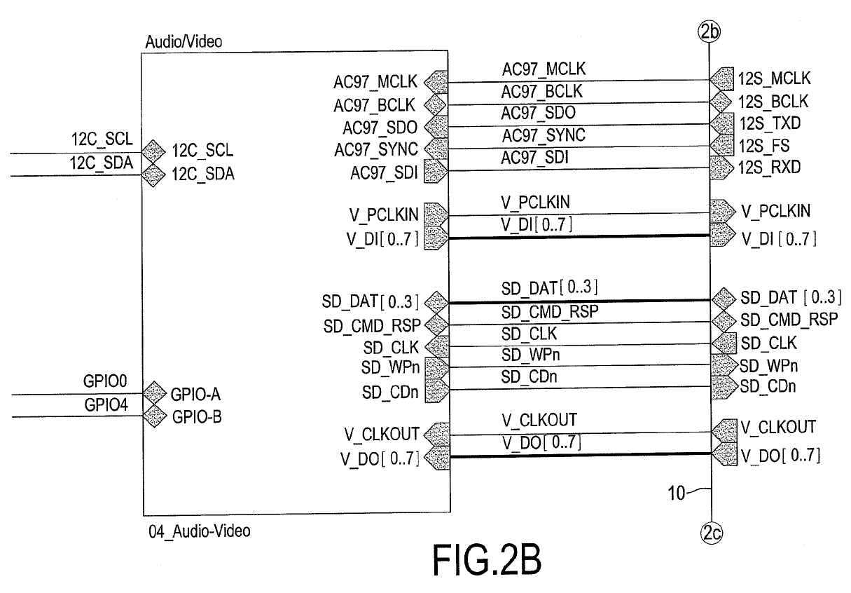

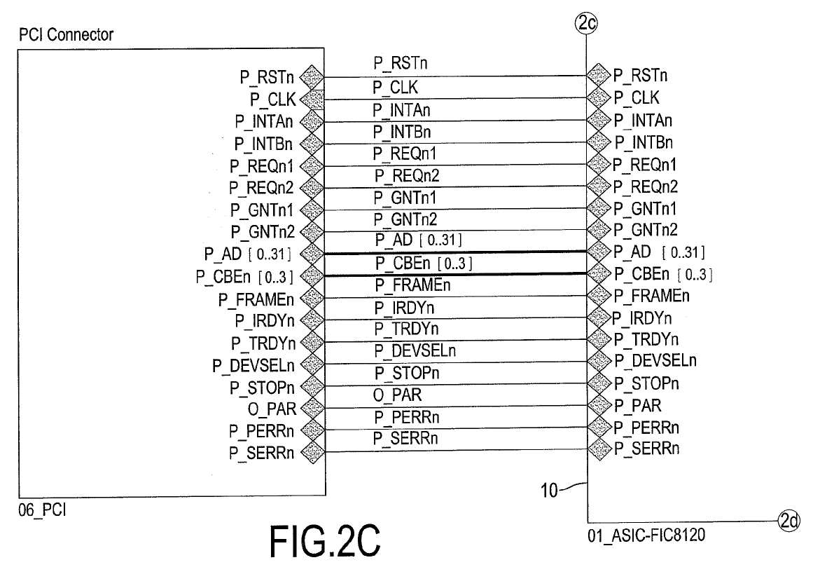

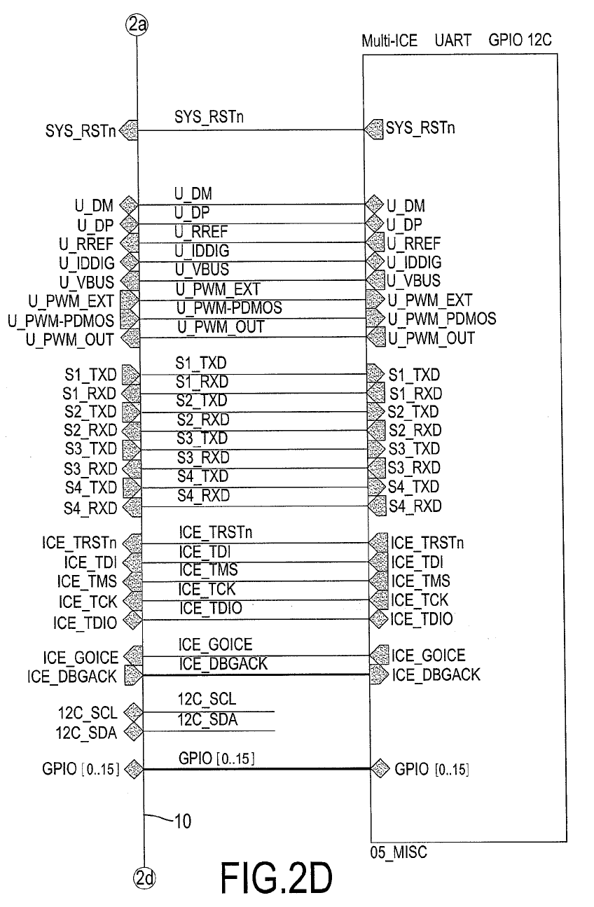

With further reference to FIGS. 2A to 2D, the processor (10) has data computing and processing capabilities and may be an integrated circuit (IC) numbered ASIC-FIC8120.

The vehicle speed sensor (11) is electronically connected to the processor (10), detects and sends speed data representing a speed of the vehicle to the processor (10).

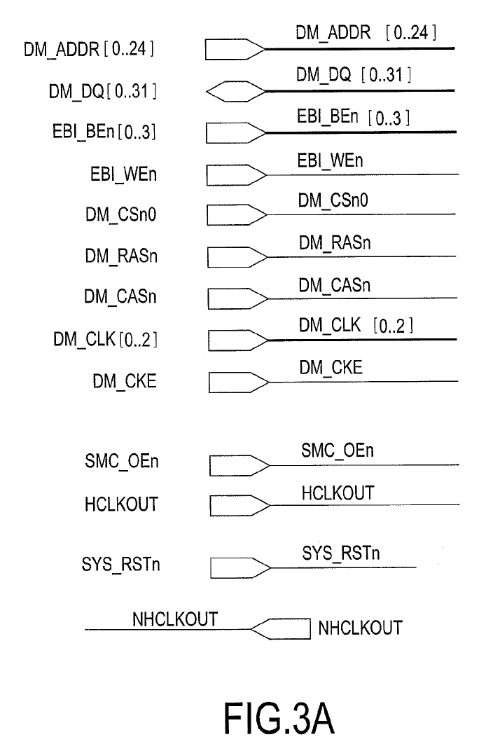

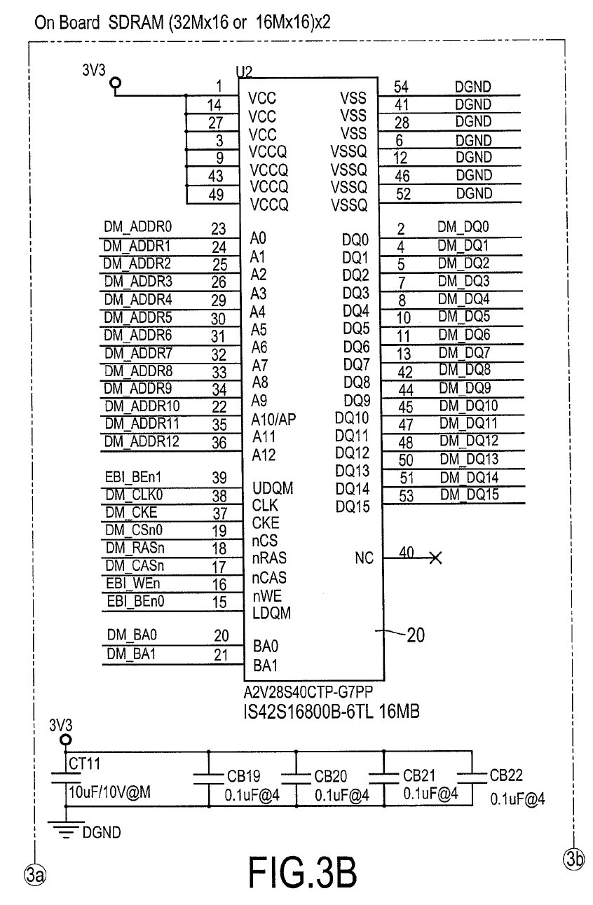

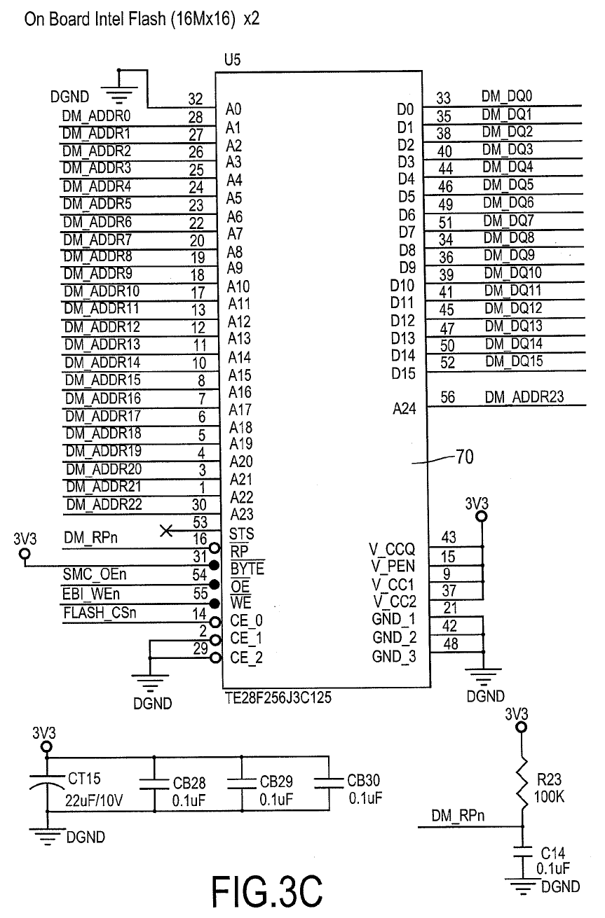

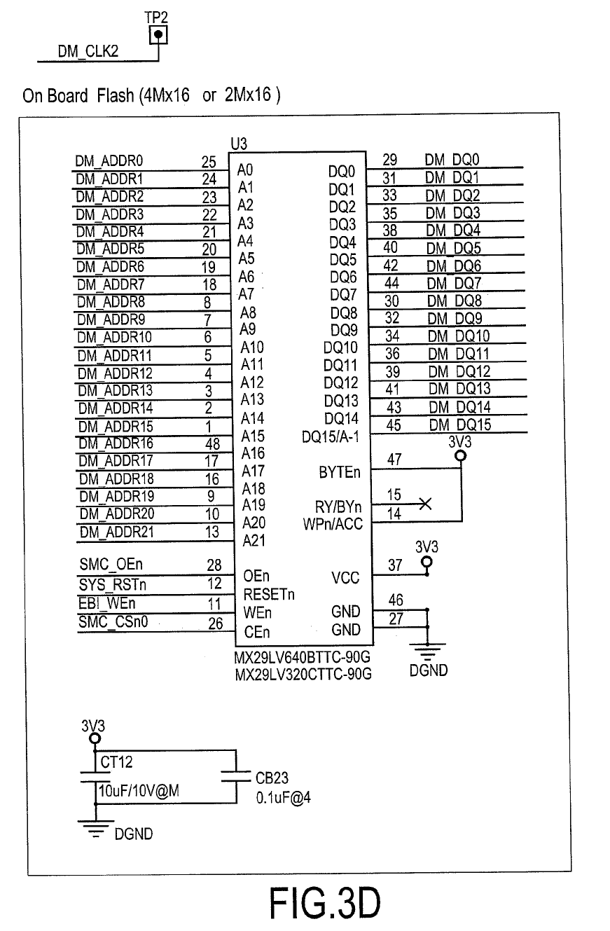

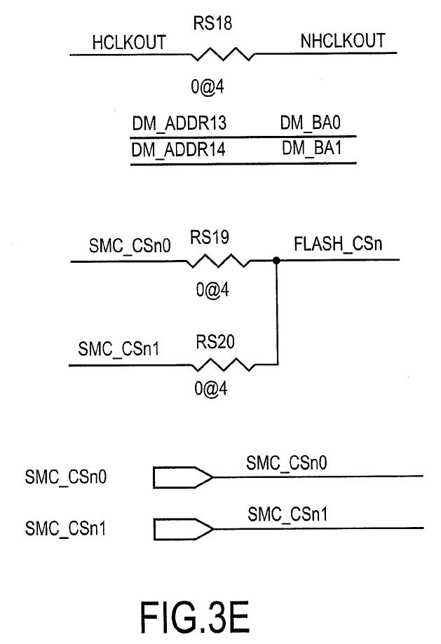

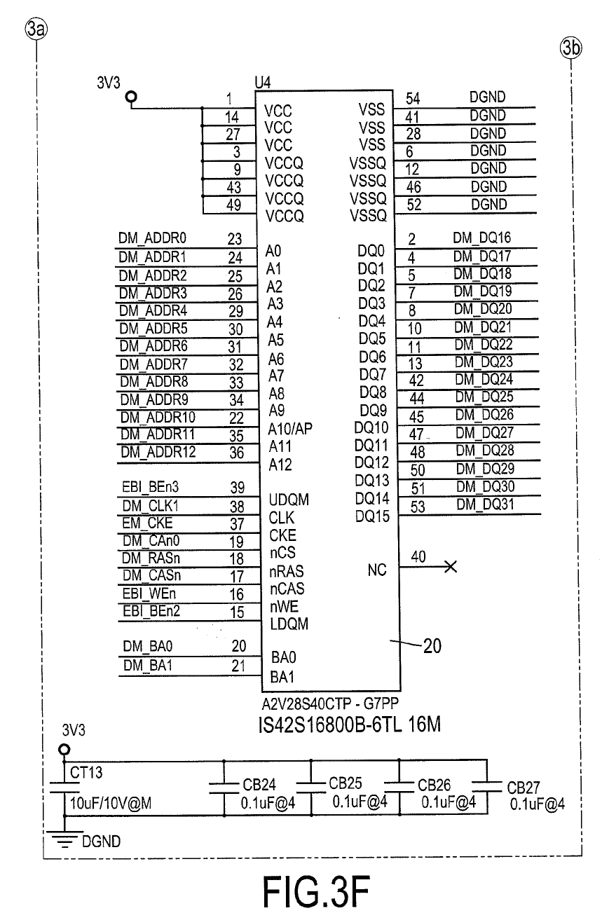

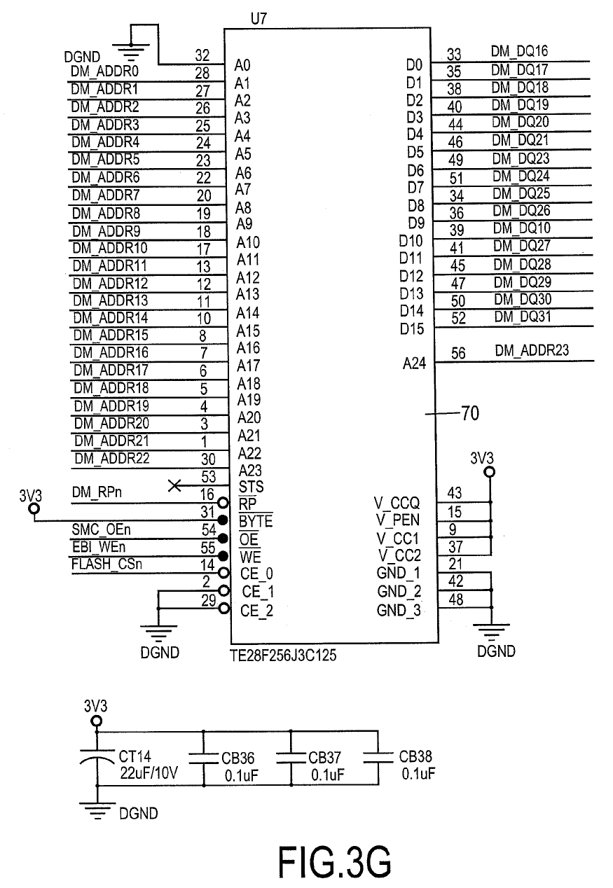

With further reference to FIGS. 3A to 3G, the register (20) is electronically connected to the processor (10) to temporarily store data that are computed and processed by the processor (10) and may comprise multiple synchronous dynamic random access memories (SDRAMs).

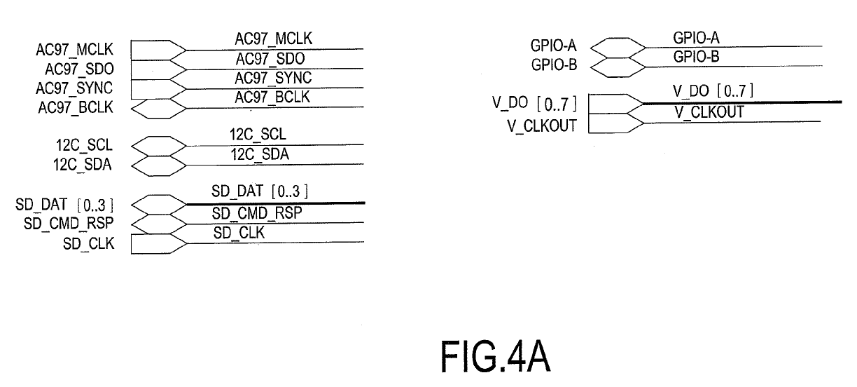

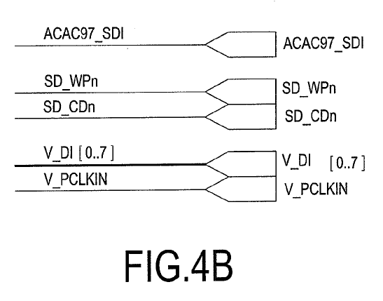

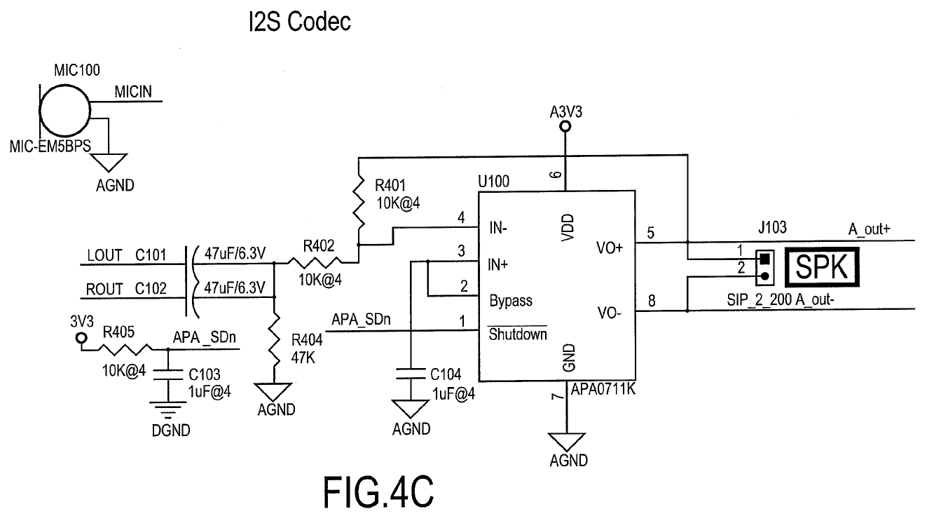

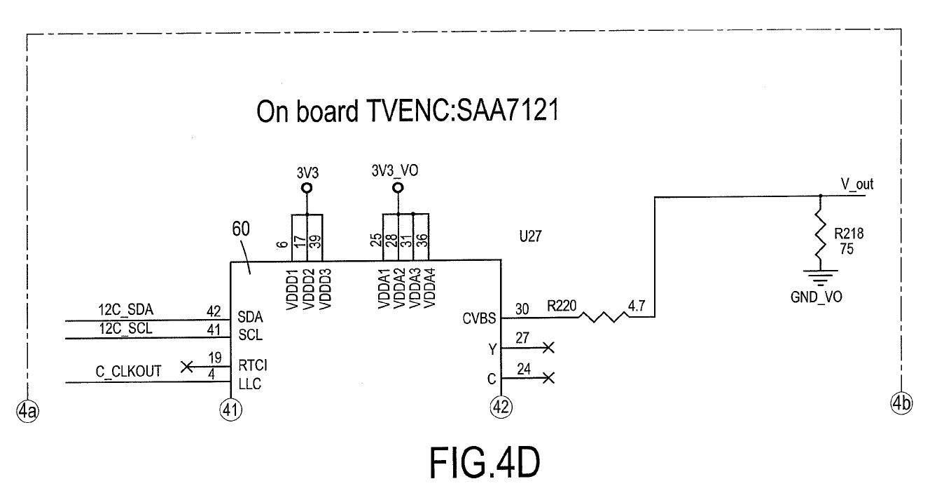

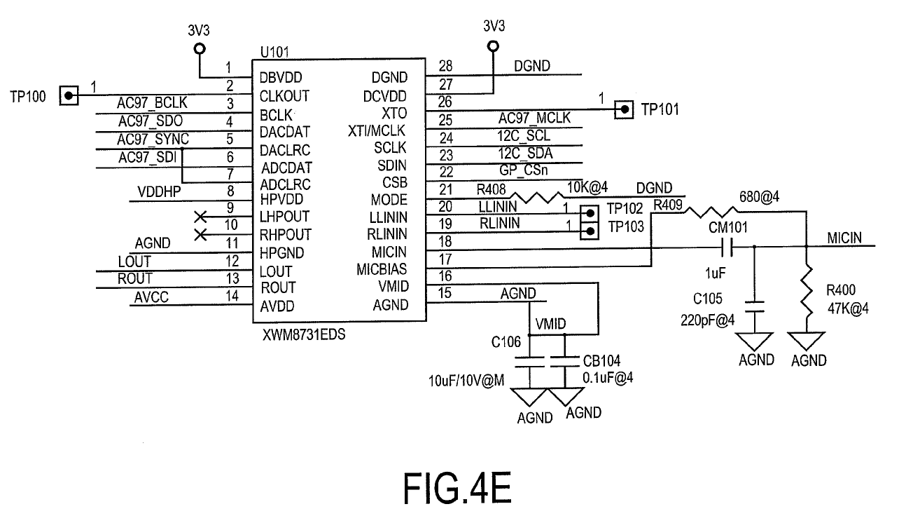

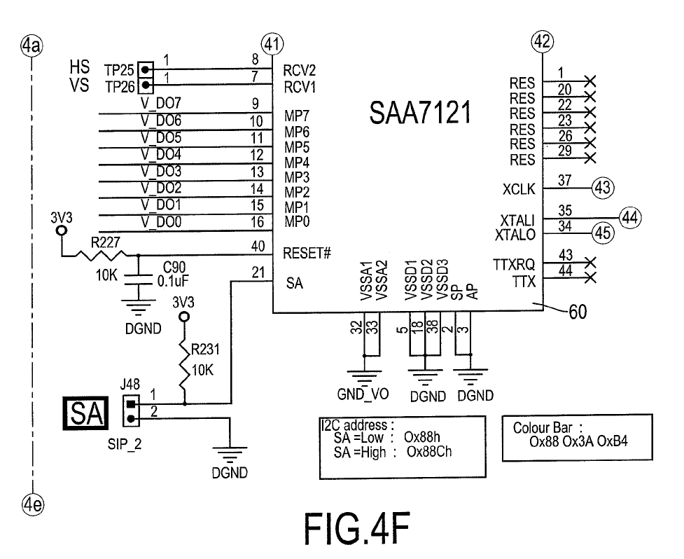

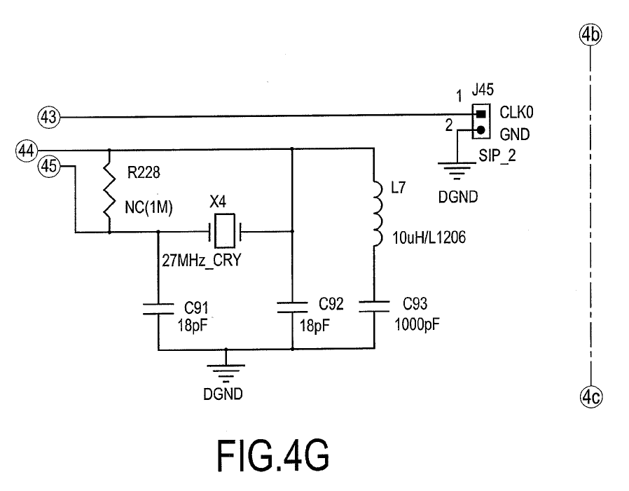

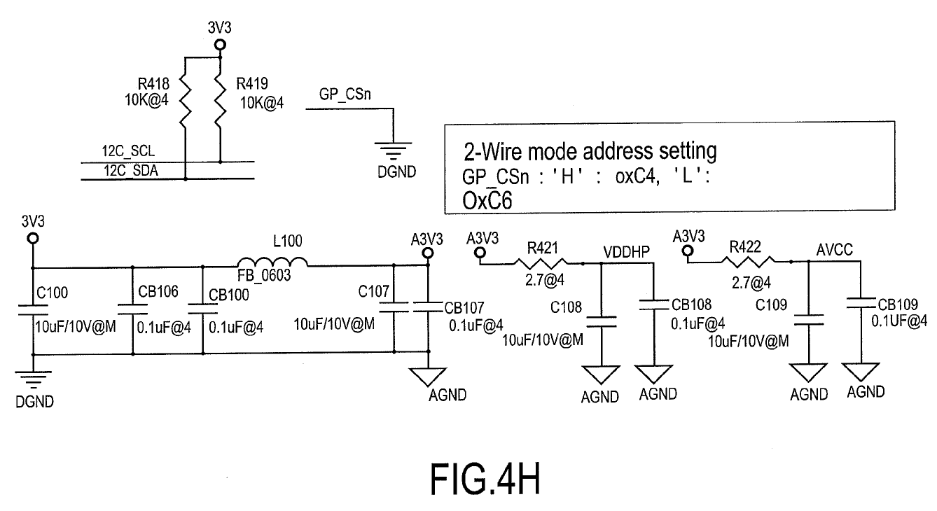

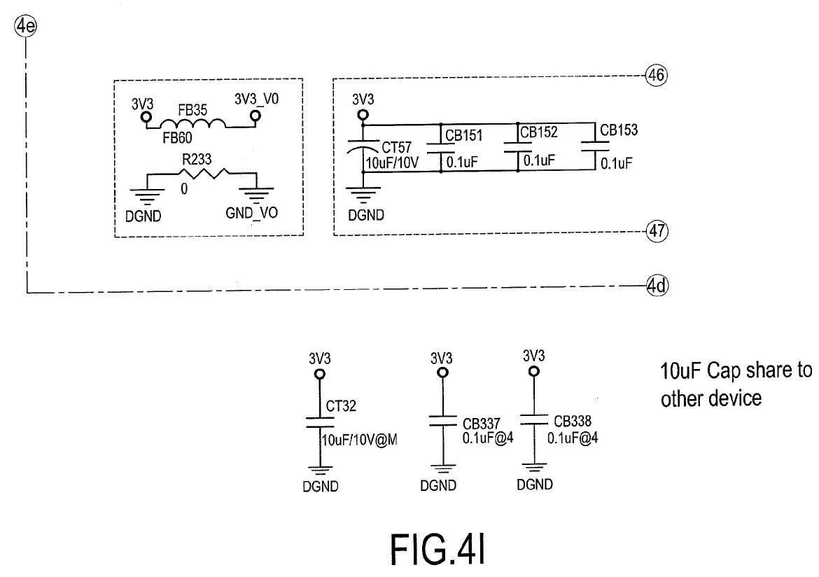

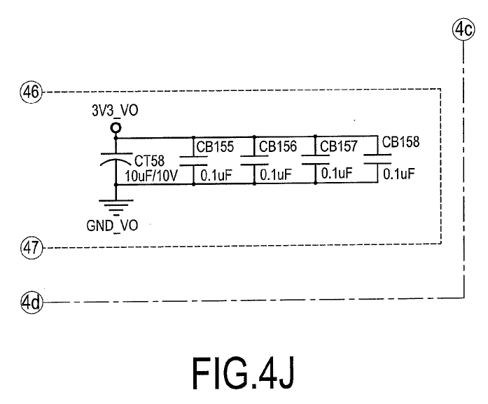

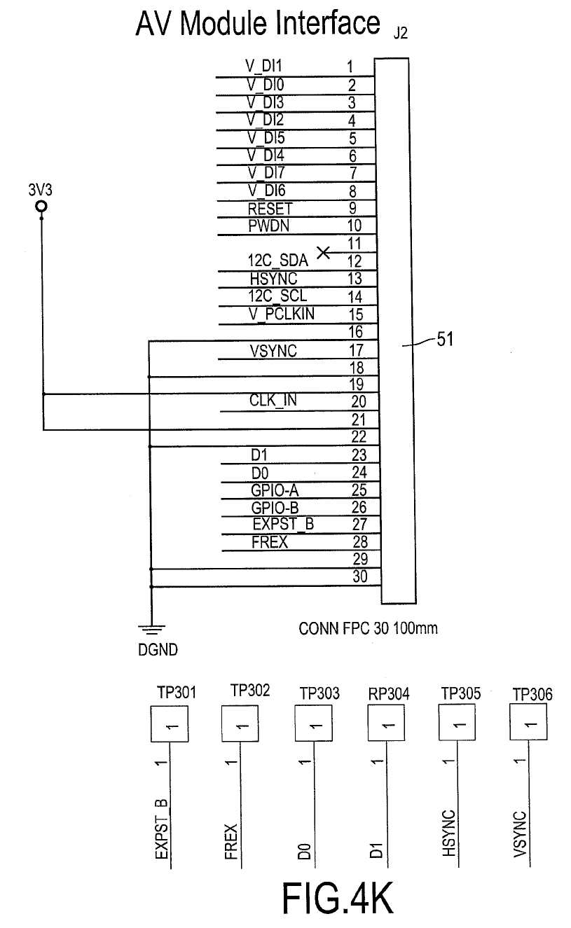

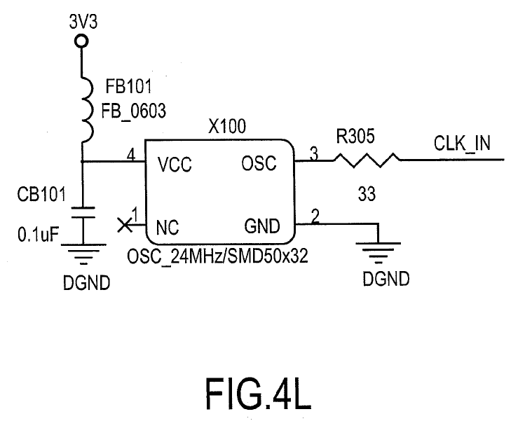

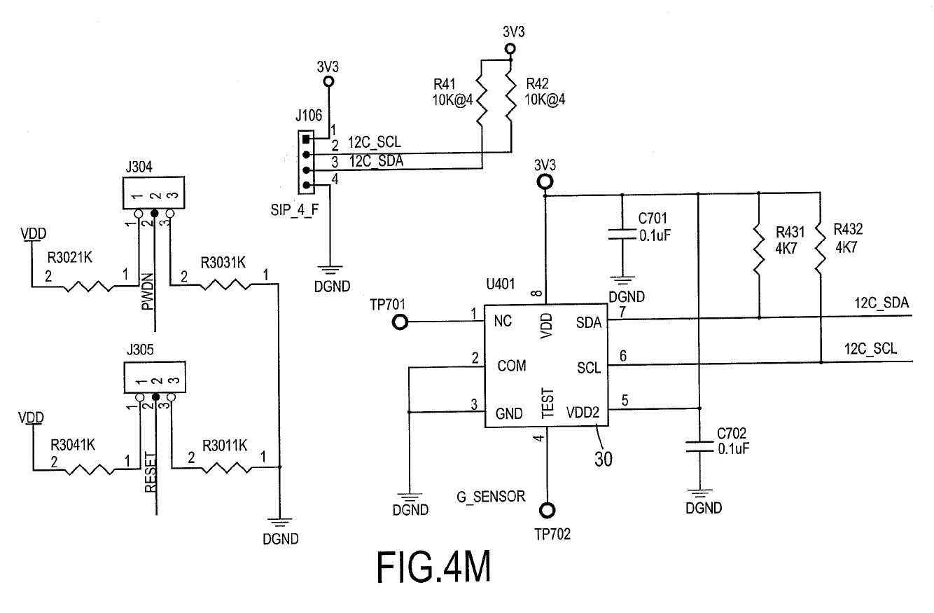

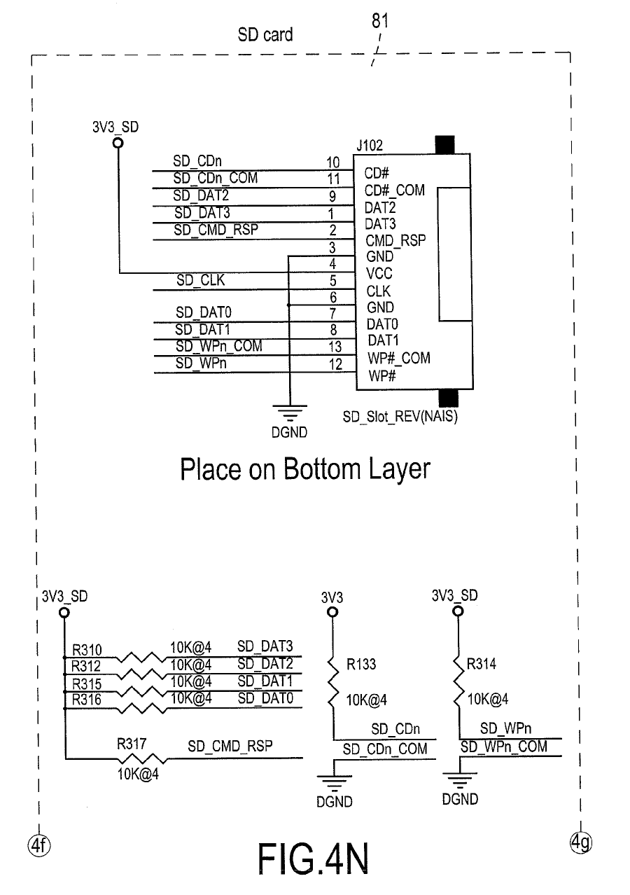

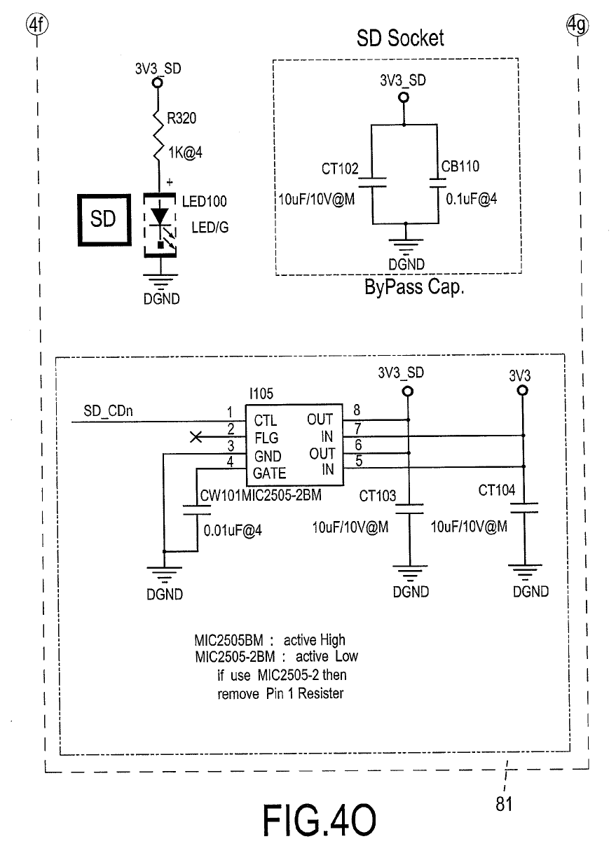

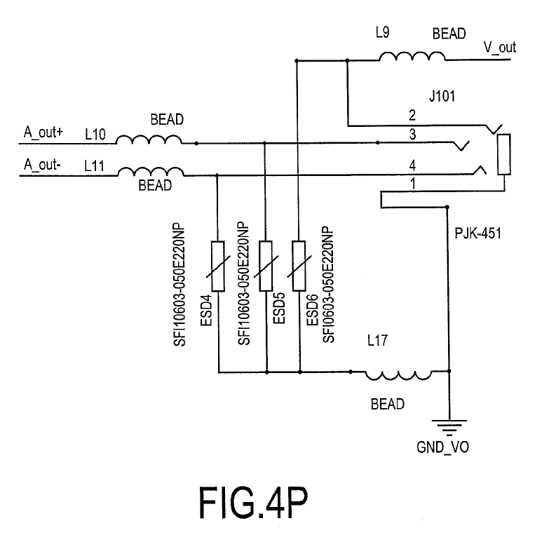

With further reference to FIGS. 4A to 4P, the gravity sensing unit (30) is electronically connected to the processor (10) and uses gravity as a reference for detecting a movement of the vehicle and may be an accelerometer (also called G sensor). Therefore, the processor (10) calculates a motion and orientation of the vehicle including, but not limited to: acceleration, deceleration (braking) orientation, rate of ascent or descent, change of direction of the vehicle, speed of change in direction or the like. Furthermore, the processor (10) determines whether the vehicle is colliding by measuring changes of the motion and orientation of the vehicle, such as sudden change in orientation, deceleration or acceleration.

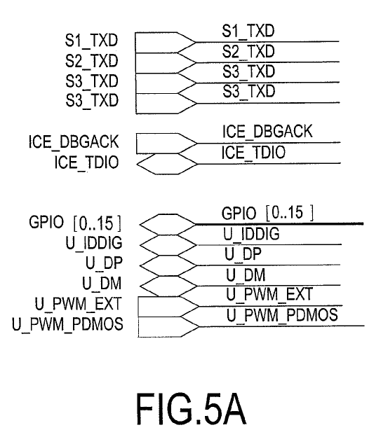

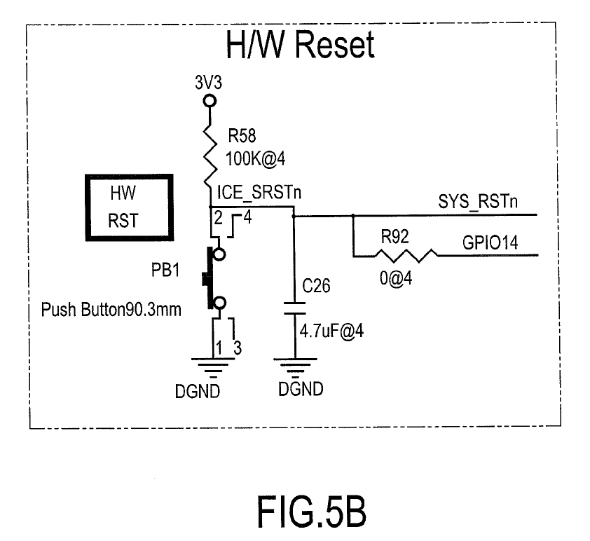

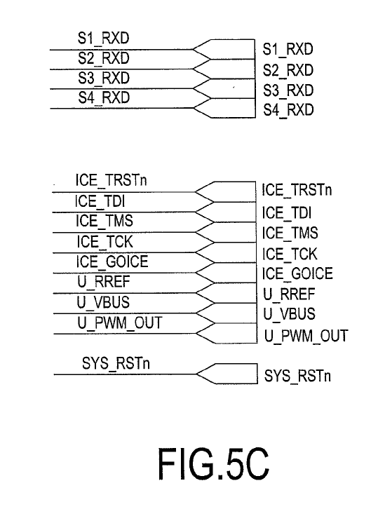

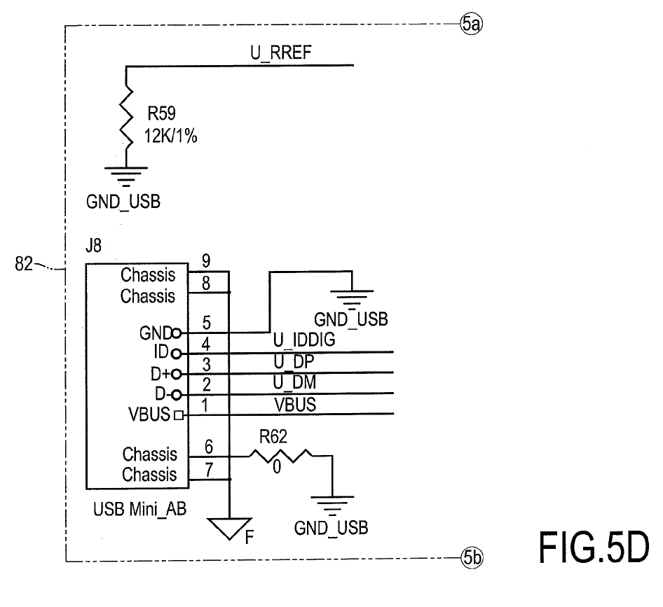

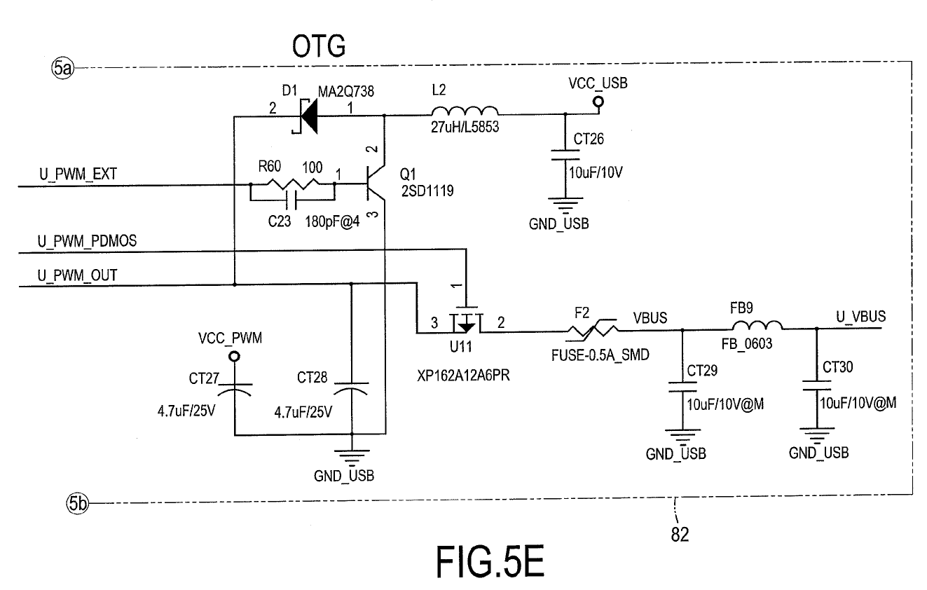

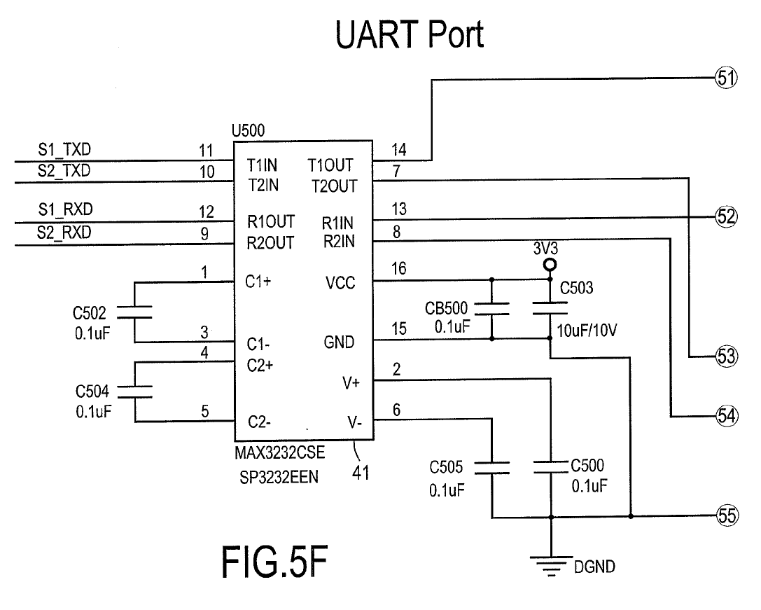

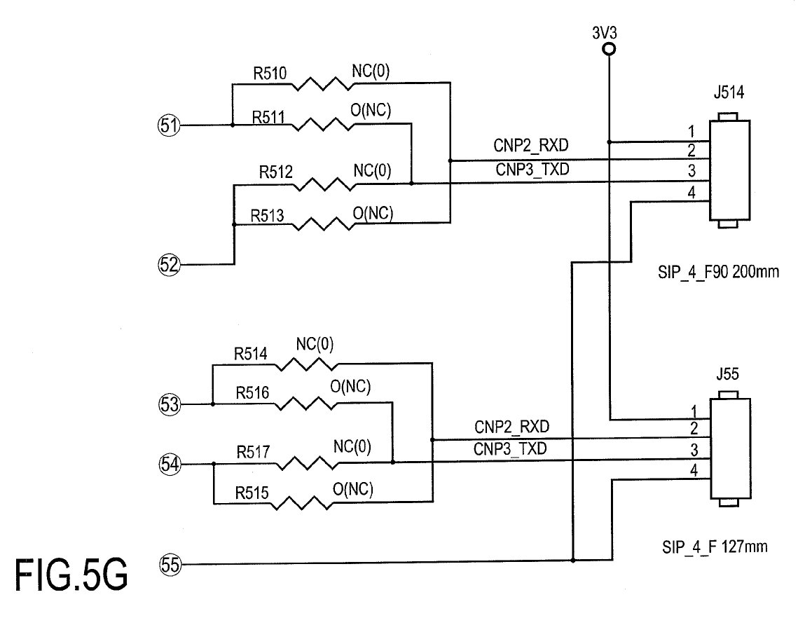

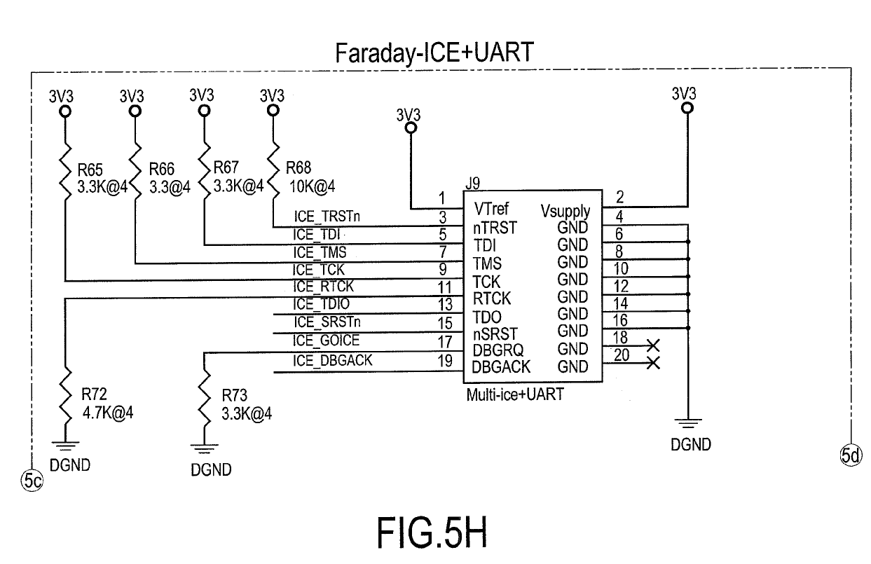

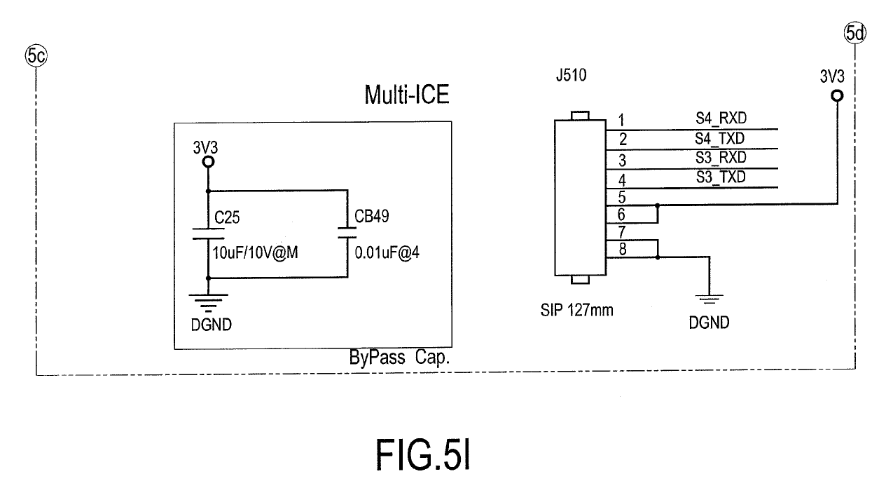

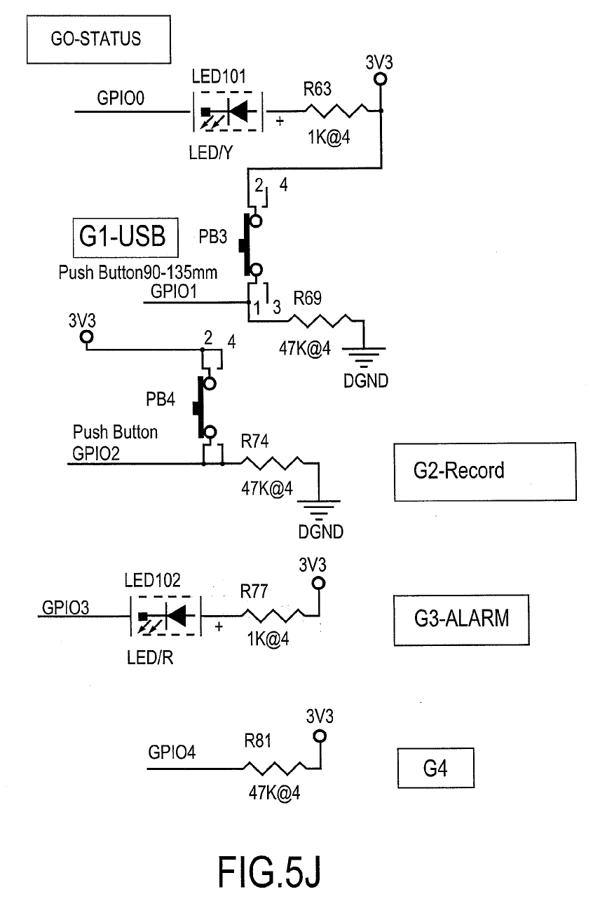

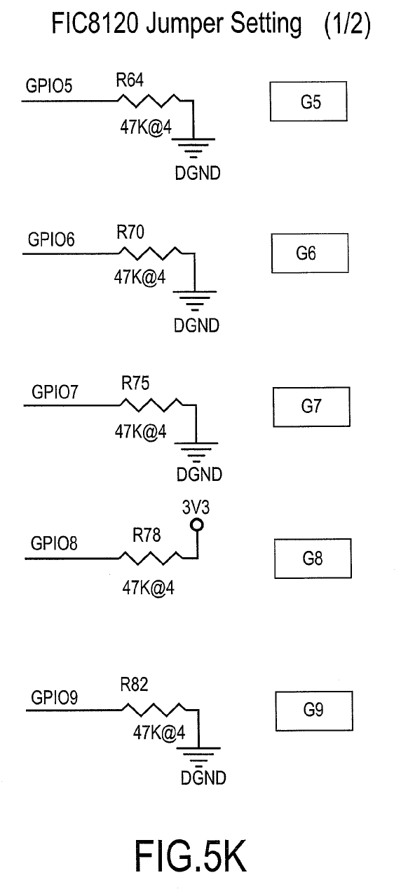

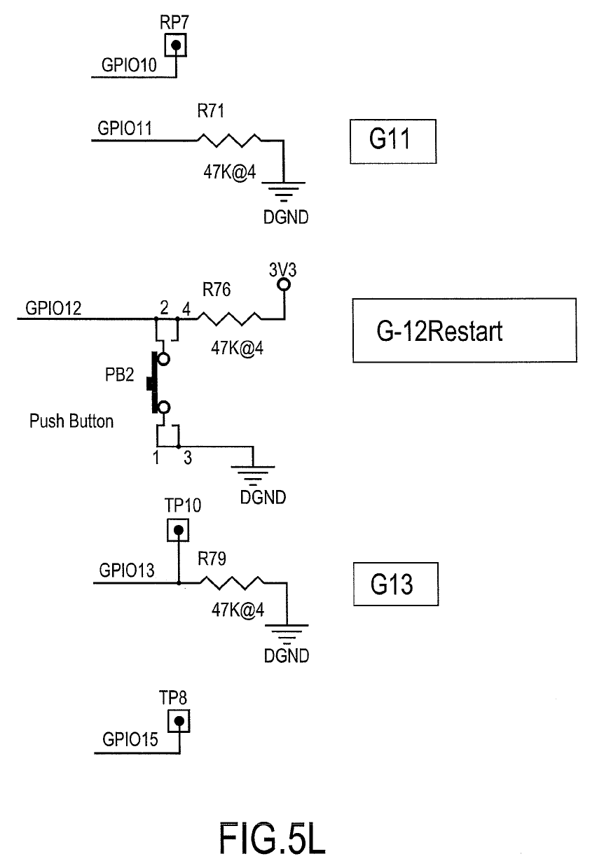

With further reference to FIGS. 5A to 5L, the magnetic field positioning unit (40) is electronically connected to the processor (10), detects a position of the magnetic field positioning unit (40) by measuring the Earth's magnetic field and may be an electronic compass. The electronic compass is electronically connected to the processor (10) through a universal asynchronous receiver and transmitter (UART) interface (41). Therefore, the processor (10) calculates a location of the vehicle from the position of the magnetic field positioning unit (40).

The camera (50) is disposed on the vehicle to capture images around the vehicle, is electronically connected to the processor (10) to transmit captured images to the processor (10) and may be further electronically connected to the processor (10) through an image transmitting interface (51).

The video encoder (60) is electronically connected to the processor (10) to encode captured images from the camera (50) through the processor (10) and may be an IC numbered SAA7121.

The storage unit (70) is electronically connected to the processor (10) to store the speed data, the motion, orientation and location of the vehicle and the encoded images and may comprise multiple flash memories.

The card type storage medium connector (81) is electronically connected to the processor (10) and allows an external card to be plugged in and connected to the card type storage medium connector (81) so the processor (10) controls the storage unit (70) exchanging data with the external card. The card type storage medium connector (81) may be but is not limited to a secure digital (SD) memory card connector to allow a SD memory card to be plugged into the SD memory card connector.

The removable storage medium connector (82) is electronically connected to the processor (10) and allows an external removable storage medium to connect to the removable storage medium connector (82) so the processor (10) controls the storage unit (70) exchanging data with the external removable storage medium. Furthermore, the removable storage medium connector (82) may be but is not limited to a universal serial bus on-the-go (USB OTG) connector to allow an external USB device to connect to the USB OTG connector or to allow the driving recorder to connect to a computer. Therefore, data from each trip may be downloaded to a computer, personal digital assistant (PDA) or the like.

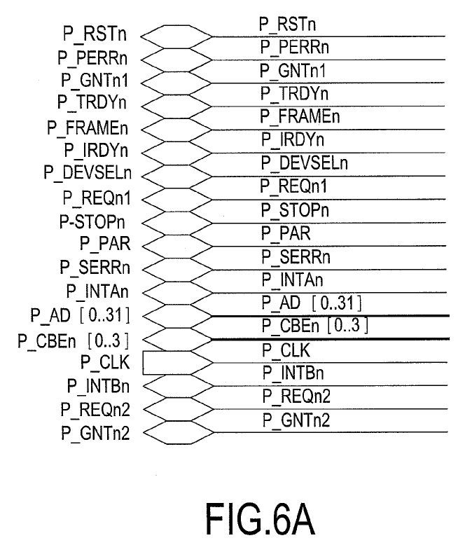

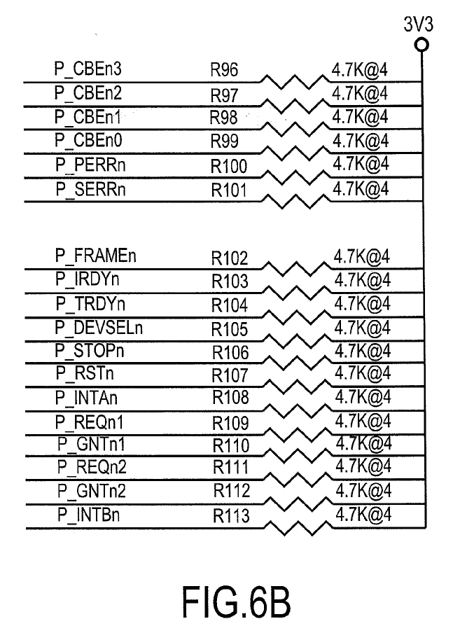

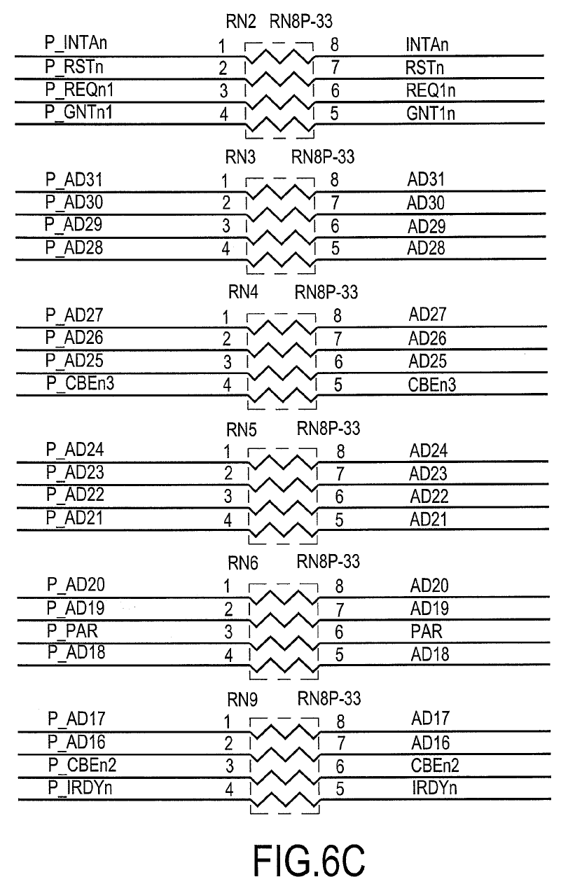

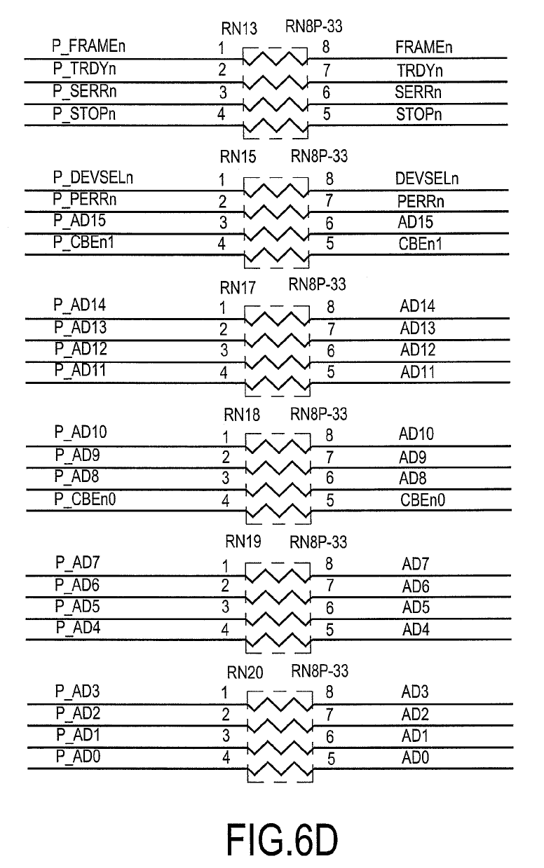

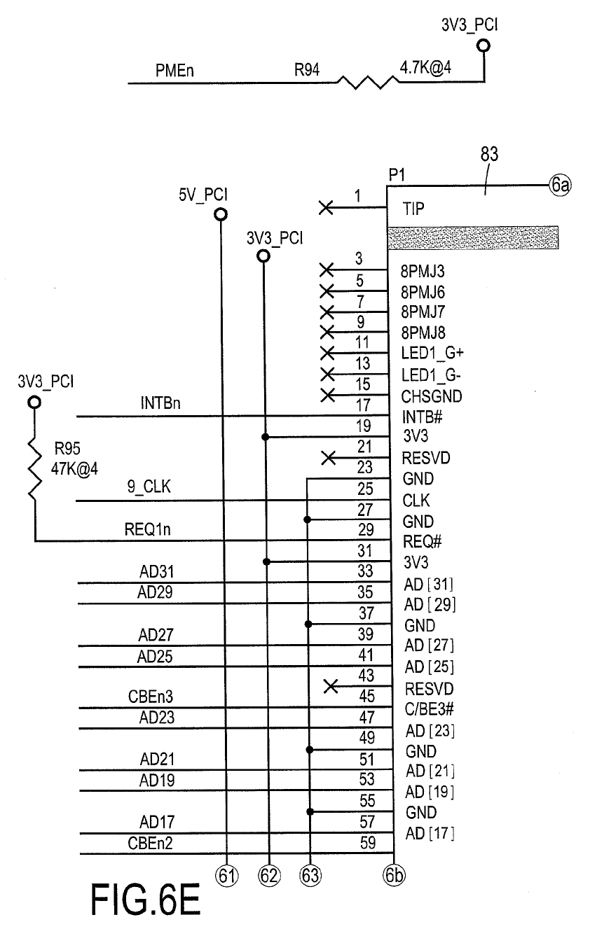

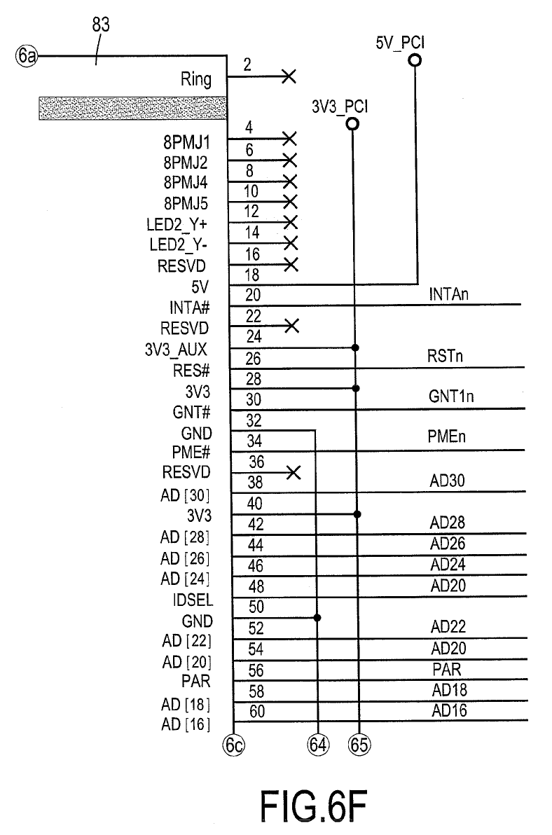

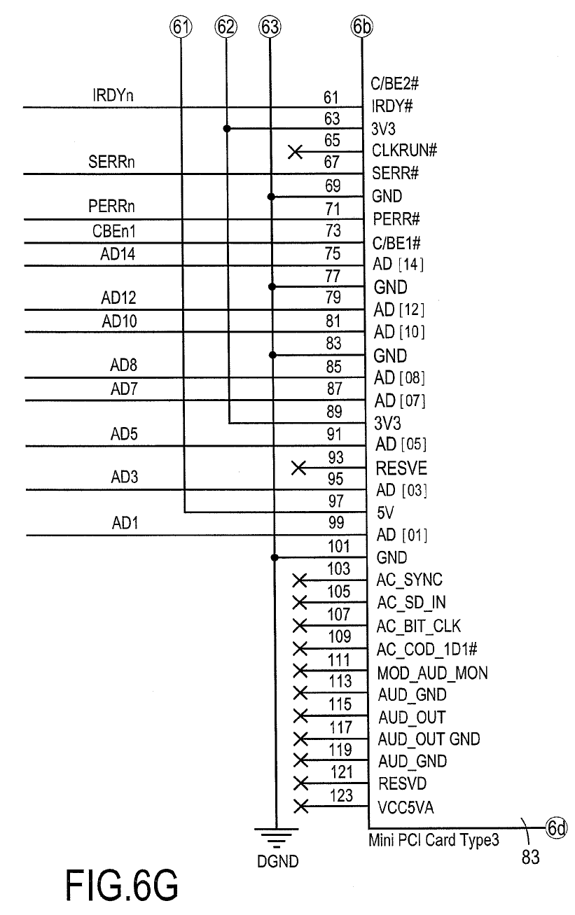

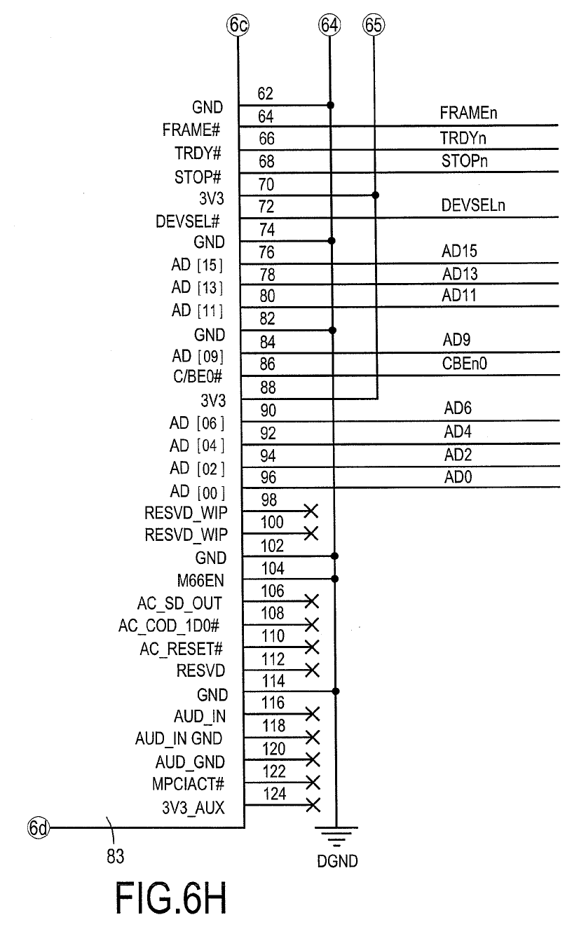

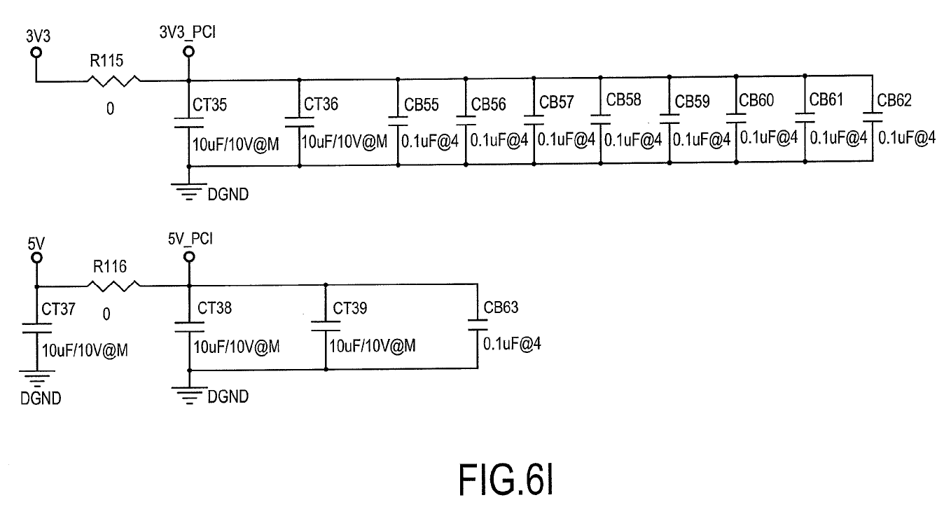

The network adapter connector (83) is electronically connected to the processor (10) and allows a network adapter (831) to be connected to the network adapter connector (83). With further reference to FIGS. 6A to 6I, the network adapter connector (83) may be a mini-peripheral component interconnect (Mini-PCI) connector, and the network adapter (831) may be a wireless network adapter to allow the driving recorder to be linked to the Internet.

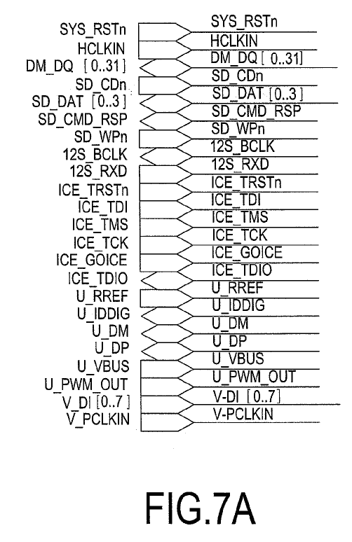

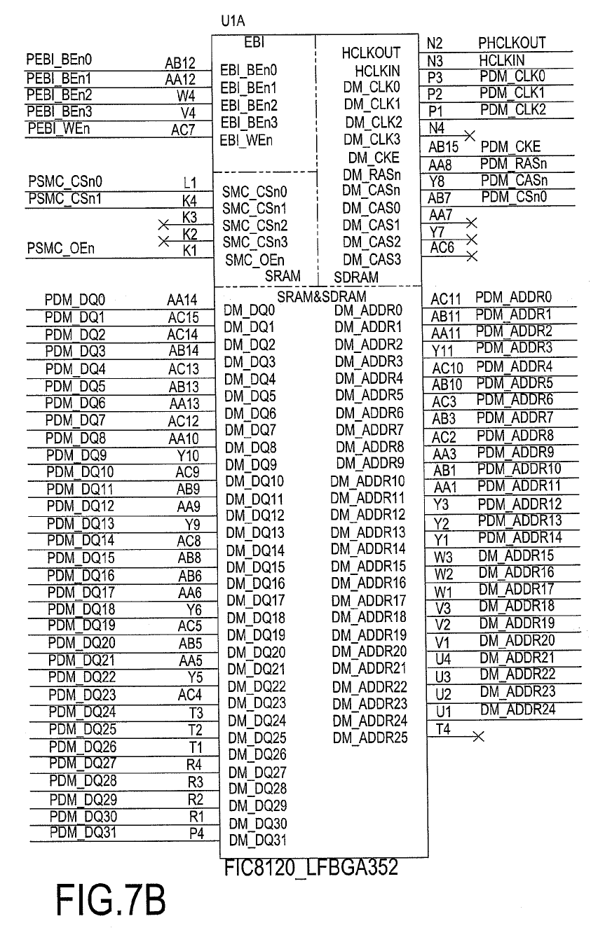

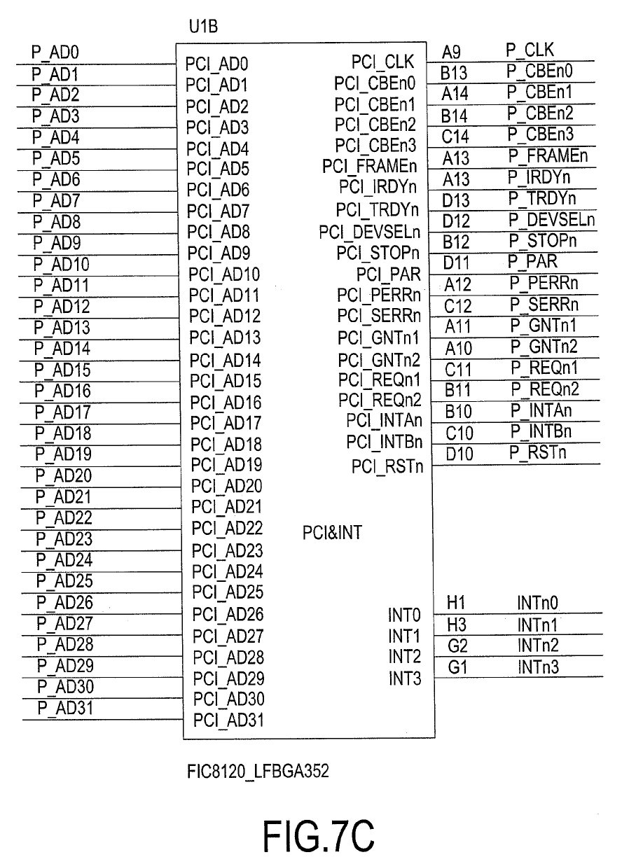

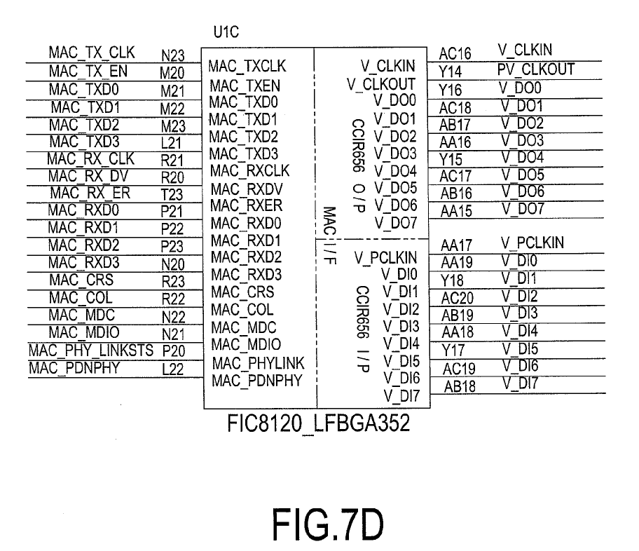

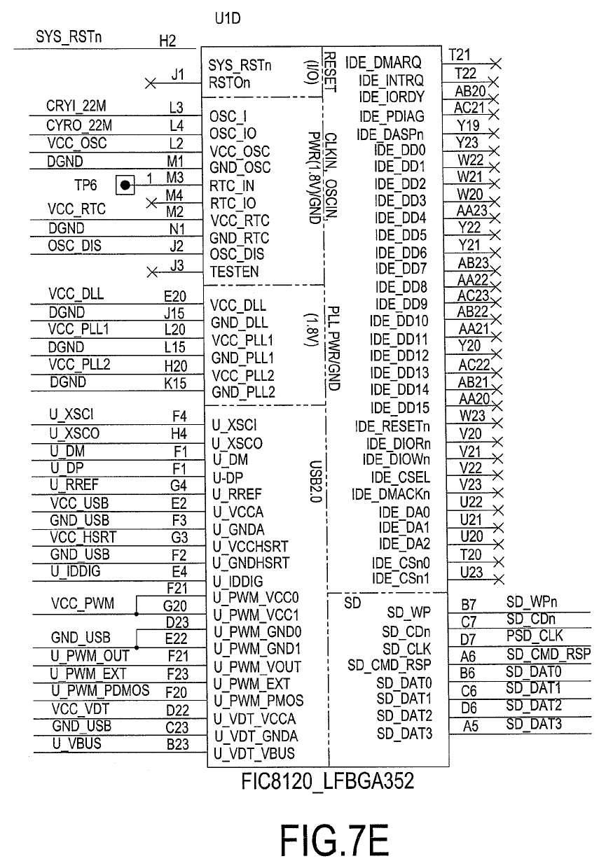

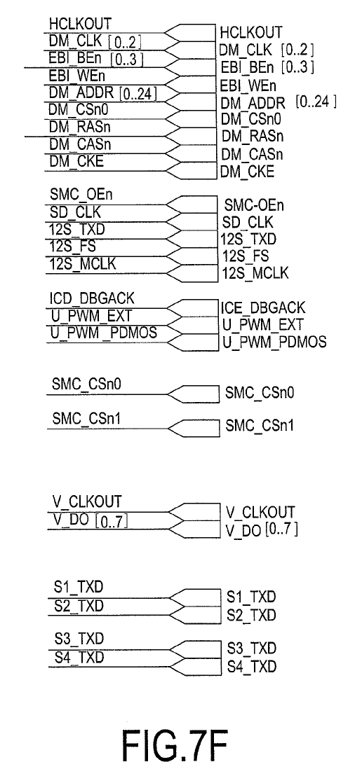

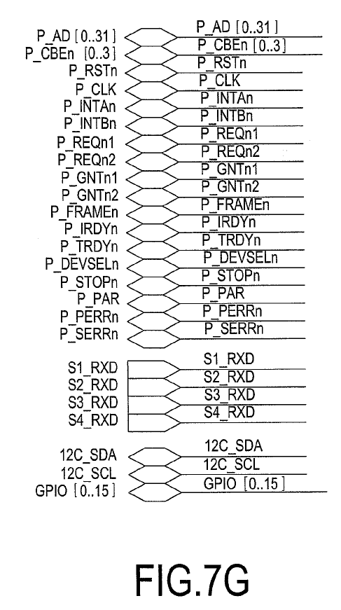

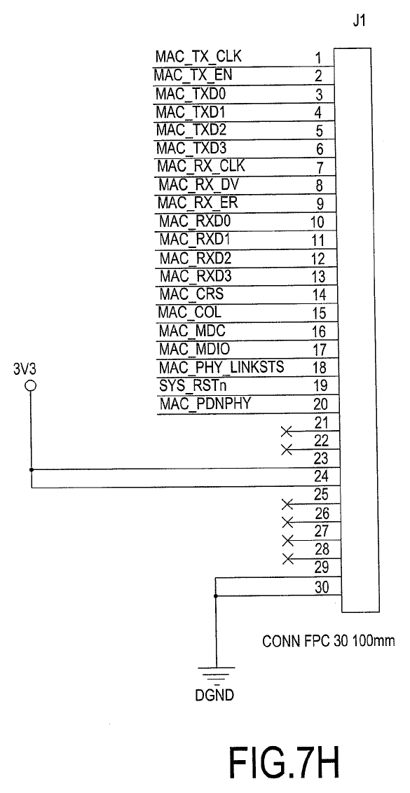

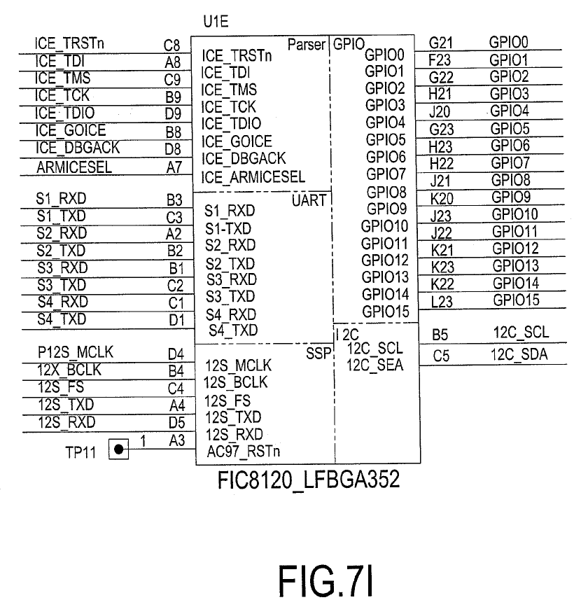

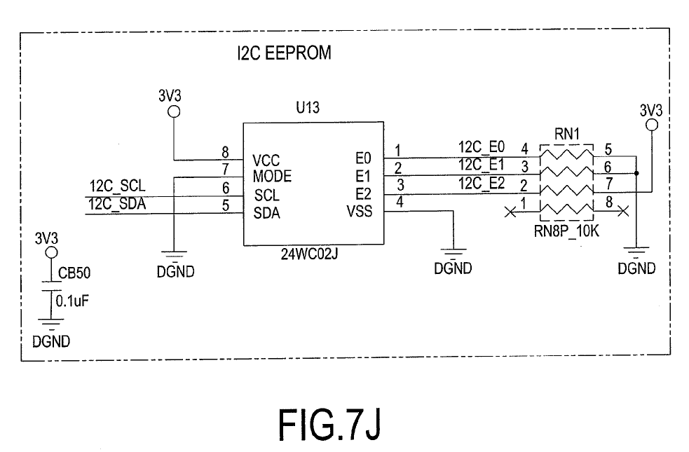

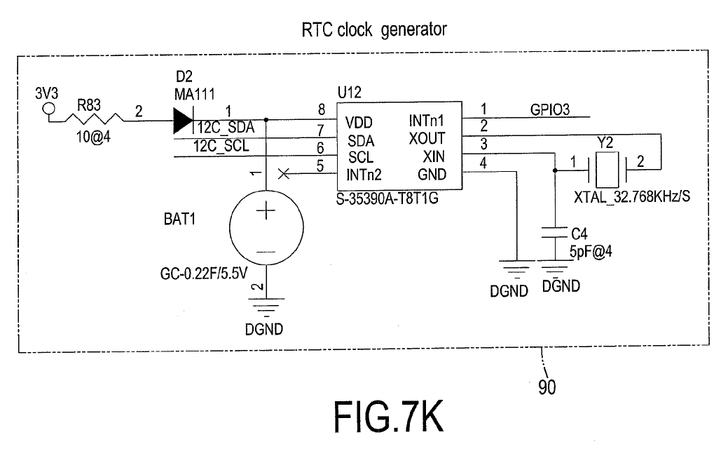

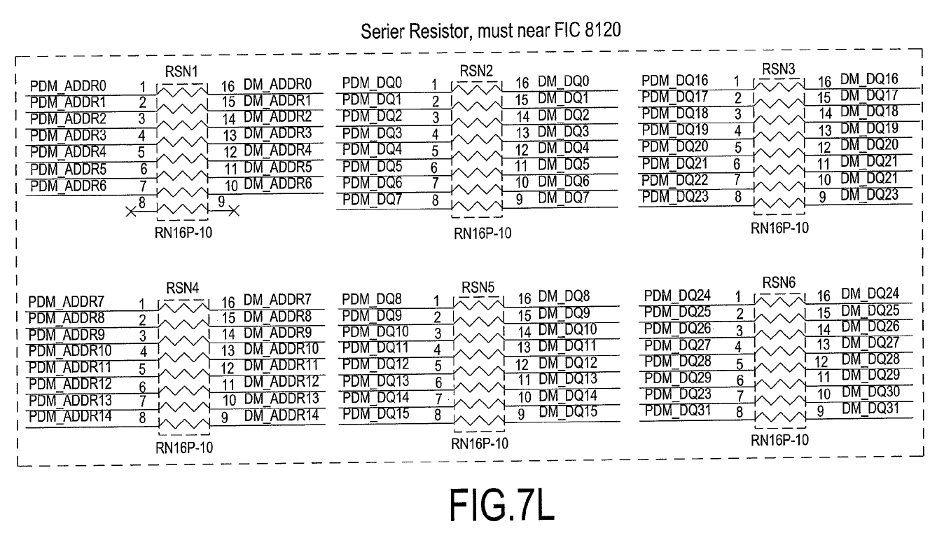

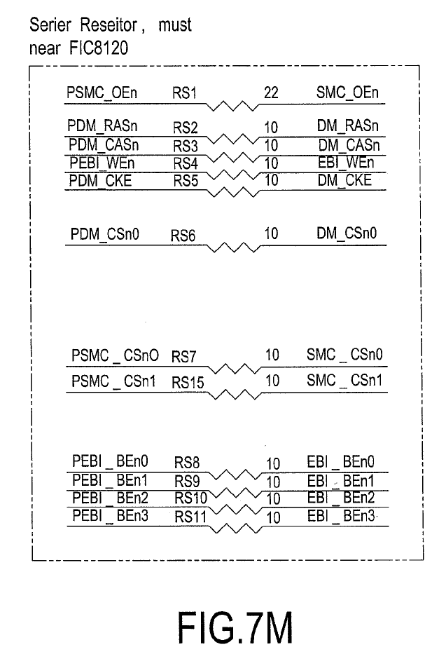

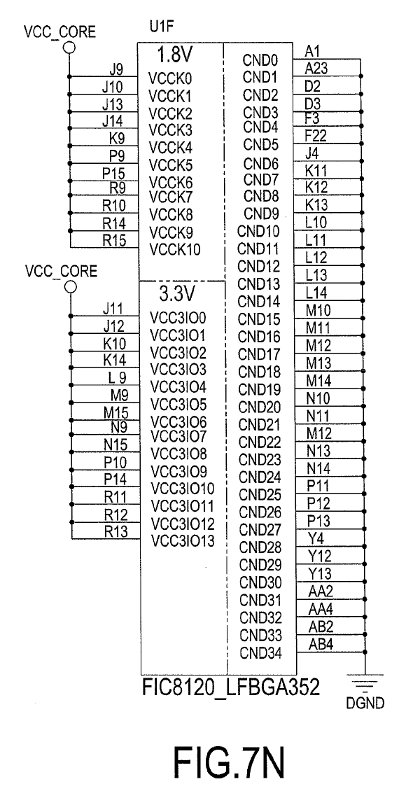

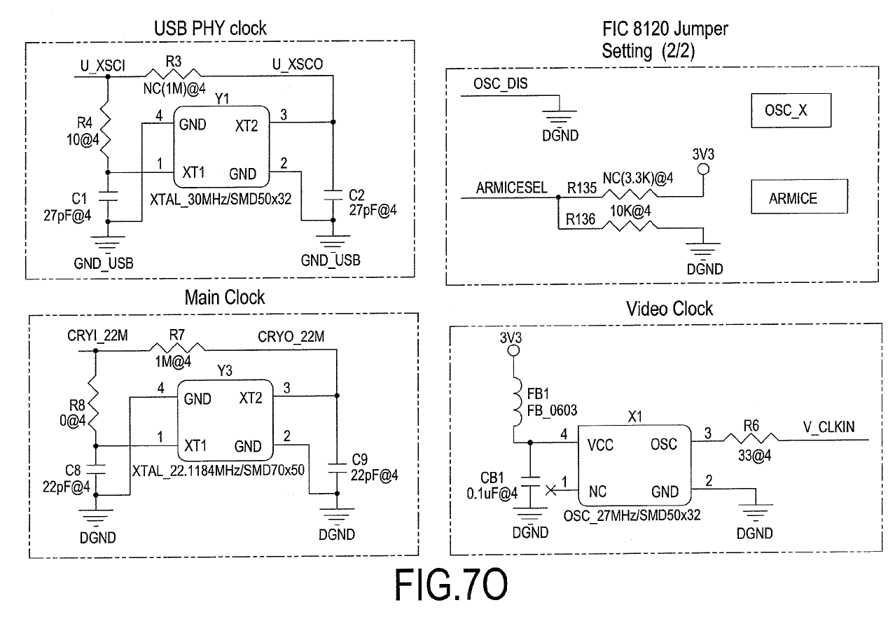

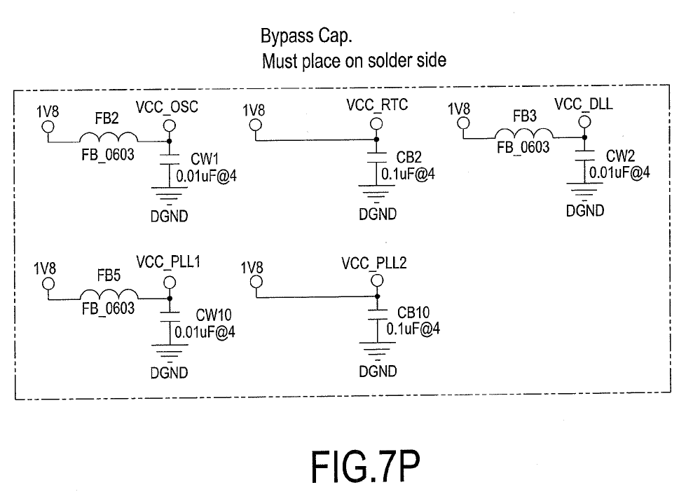

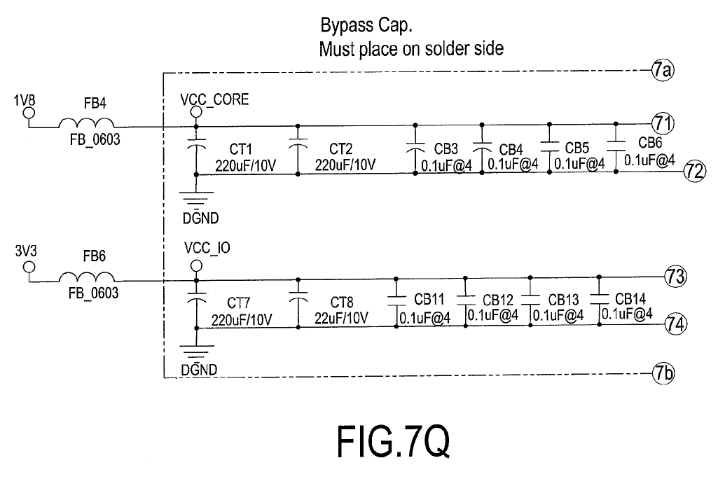

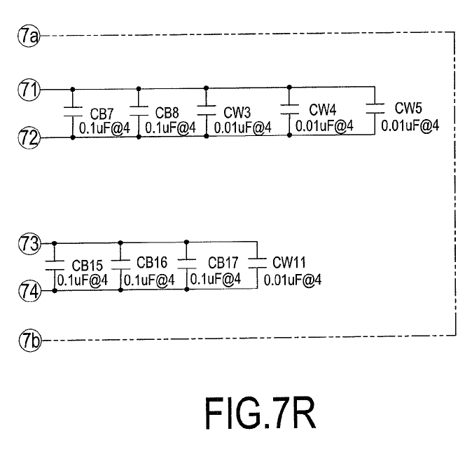

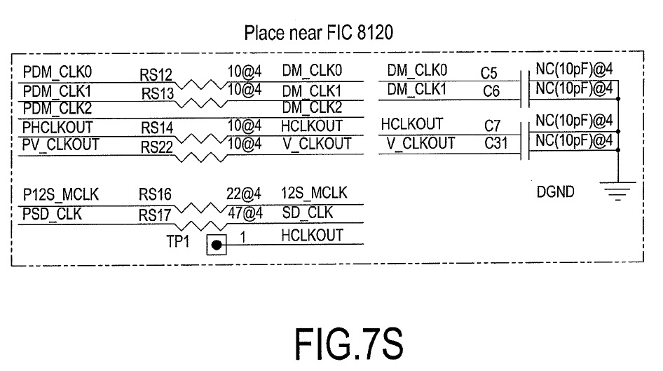

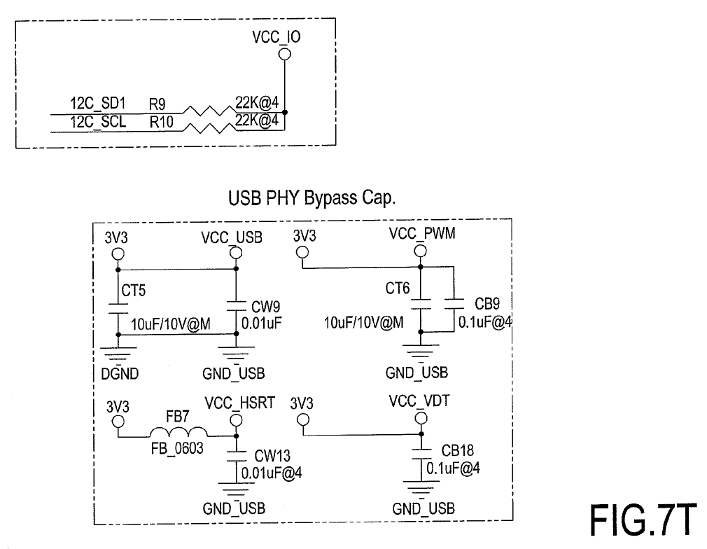

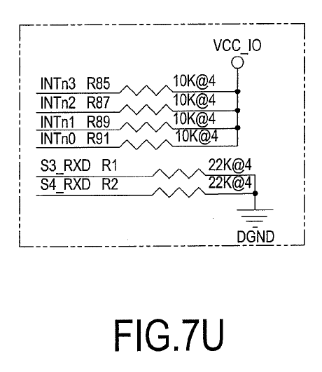

The clock unit (90) is electronically connected to the processor (10) to calculate time and date so the processor (10) stores the time and date in the storage unit (70) with data corresponding to that time and date including speed data, the motion and orientation of the vehicle, the location of the vehicle and the images, may be encoded images, in the storage unit (70). Furthermore, with further reference to FIGS. 7A to 7U, the clock unit (90) may be a real time clock (RTC).

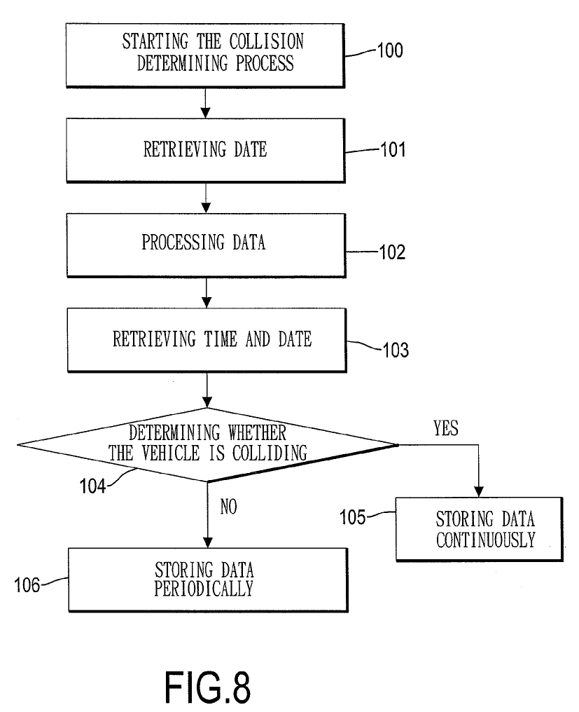

With further reference to FIG. 8, the processor (10) may execute a collision determining process using a predetermined collision standard value and comprising acts of starting the collision determining process (100), retrieving data (101), processing data (102), retrieving time and date (103), determining whether the vehicle is colliding (104), storing data continuously (105) when the vehicle is colliding and storing data periodically (106) when the vehicle has not collided.

The act of retrieving data (101) comprises retrieving speed data from the speed sensor (11), the movement of the vehicle relative to gravity from the gravity sensing unit (30), the position of the magnetic field positioning unit (40) and the images from the camera (50).

The act of processing data (102) comprises calculating a motion and orientation of the vehicle from the movement of the vehicle relative to gravity, calculating a location of the vehicle from the position of the magnetic field positioning unit (40) and sending the images to the video encoder (60) to encode the images.

The act of retrieving time and date (103) comprises retrieving the time and date from the clock unit (90).

The act of determining whether the vehicle is colliding (104) comprises determining whether a value of the movement of the vehicle relative to gravity is larger than the collision standard value. When the value of the movement of the vehicle relative to gravity larger than the collision standard value is calculated, the processor (10) determines that the vehicle is colliding, and the act of storing data continuously (105) is executed to continuously store the speed data, the motion and orientation of the vehicle, the location of the vehicle, the images, may be the encoded images, and the time and date in the storage unit (70). When the value of the movement of the vehicle relative to gravity less than the collision standard value is calculated, the processor (10) determines that the vehicle has not collided, and the act of storing data periodically (106) is executed to periodically store the speed data, the motion and orientation of the vehicle, the location of the vehicle, the images, may be the encoded images, and the time and current data in the storage unit (70).

Based on the foregoing descriptions, the driving recorder of the present invention detects the motion and orientation of the vehicle and changes to the vehicle from the gravity sensing unit (30). Accordingly, the driving recorder of the present invention does not require being connected to a steering wheel, throttle and brake of the vehicle. Consequently, wire routing in the vehicle when installing the driving recorder of the present invention in the vehicle is simpler than for a conventional driving recorder in the vehicle. Additionally, the driving recorder of the present invention detects the location of the vehicle from the magnetic field positioning unit (40). The magnetic field positioning unit (40) does not require receiving signals transmitted by satellites to determine the location of the vehicle. Therefore, the driving recorder of the present invention still detects the location of the vehicle even when the vehicle is being driven in a tunnel.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A driving recorder installed on a vehicle and comprising:
a processor having data computing and processing capabilities;
a register being electronically connected to the processor to temporarily store data that are computed and processed by the processor;
a gravity sensing unit being electronically connected to the processor and using gravity as a reference for detecting a movement of the vehicle to allow the processor to calculate a motion and orientation of the vehicle and determine whether the vehicle is colliding according to the motion and orientation of the vehicle;
a magnetic field positioning unit being electronically connected to the processor and detecting a position of the magnetic field positioning unit by measuring the Earth's magnetic field to allow the processor to calculate a location of the vehicle from the position of the magnetic field positioning unit;
a camera captured images around the vehicle, being electronically connected to the processor and transmitting the images to the processor; and
a storage unit being electronically connected to the processor to store the motion, orientation and location of the vehicle and the images.

2. The driving recorder as claimed in claim 1 further comprising a clock unit being electronically connected to the processor and calculating time and date to allow the processor to store the time and date in the storage unit with data corresponding to the time and date.

3. The driving recorder as claimed in claim 1 further comprising a vehicle speed sensor being electronically connected to the processor, detecting and sending speed data representing a speed of the vehicle to the processor to allow the processor to store the speed data in the storage unit.

4. The driving recorder as claimed in claim 2 further comprising a vehicle speed sensor being electronically connected to the processor, detecting and sending speed data representing a speed of the vehicle to the processor to allow the processor to store the speed data in the storage unit with the time and date.

5. The driving recorder as claimed in claim 4, wherein the processor further stores
a collision standard value; and
a collision determining process comprising acts of
retrieving data comprising retrieving speed data, the movement of the vehicle relative to gravity, the position of the magnetic field positioning unit and the images around the vehicle;
processing data comprising calculating a motion and orientation of the vehicle from the movement of the vehicle relative to gravity and calculating a location of the vehicle from the position of the magnetic field positioning unit;
retrieving time and date comprising retrieving the time and date from the clock unit;
determining whether the vehicle is colliding comprising determining whether a value of the movement of the vehicle relative to gravity is larger than the collision standard value;
storing data continuously when the vehicle is colliding comprising continuously storing the speed data, the motion and orientation of the vehicle, the location of the vehicle, the images and the time and date in the storage unit; and
storing data periodically when the vehicle has not collided comprising periodically storing the speed data, the motion and orientation of the vehicle, the location of the vehicle, the images and the time and date in the storage unit.

6. The driving recorder as claimed in claim 1, wherein the gravity sensing unit is an accelerometer.

7. The driving recorder as claimed in claim 1, wherein the magnetic field positioning unit is an electronic compass being electronically connected to the processor through a universal asynchronous receiver and transmitter interface.

8. The driving recorder as claimed in claim 6, wherein the magnetic field positioning unit is an electronic compass being electronically connected to the processor through a universal asynchronous receiver and transmitter interface.

9. The driving recorder as claimed in claim 5 further comprising
a video encoder being electronically connected to the processor to encode the captured images from the camera through the processor; and
the act of processing data of in the collision determining process further comprises sending the images to the video encoder to encode the images;
the act of storing data continuously comprises continuously storing the encoded images in the storage unit; and
the act of storing data periodically comprises periodically storing the encoded images in the storage unit

10. The driving recorder as claimed in claim 1 further comprising a card type storage medium connector being electronically connected to the processor and allowing an external card to be plugged in and connected to the card type storage medium connector so the processor controls the storage unit exchanging data with the external card.

11. The driving recorder as claimed in claim 1 further comprising a removable storage medium connector being electronically connected to the processor and allowing an external removable storage medium to be connected to the removable storage medium connector so the processor controls the storage unit exchanging data with the external removable storage medium.

12. The driving recorder as claimed in claim 10 further comprising a removable storage medium connector being electronically connected to the processor and allowing an external removable storage medium to be connected to the removable storage medium connector so the processor controls the storage unit exchanging data with the external removable storage medium.

13. The driving recorder as claimed in claim 1 further comprising a network adapter connector being electronically connected to the processor and allowing a network adapter to be connected to the network adapter connector.

14. The driving recorder as claimed in claim 11 further comprising a network adapter connector being electronically connected to the processor and allowing a network adapter to be connected to the network adapter connector.

15. The driving recorder as claimed in claim 12 further comprising a network adapter connector being electronically connected to the processor and allowing a network adapter to be connected to the network adapter connector.

16. The driving recorder as claimed in claim 1, wherein the camera is electronically connected to the processor through an image transmitting interface.
